(19) United States
(12) Patent Application Publication
(10) Pub. No.: US 2025/0109265 A1
(43) Pub. Date: Apr. 3, 2025

(54) CLADS HAVING POLYMER FILMS AND METAL LAYERS

(71) Applicants: DUPONT ELECTRONICS, INC., WILMINGTON, DE (US); DUPONT ELECTRONIC MATERIALS INTERNATIONAL, LLC, MARLBOROUGH, MA (US)

(72) Inventors: ROSA IRENE GONZALEZ, CIRCLEVILLE, OH (US); LAILA MACLAUGHLIN, CIRCLEVILLE, OH (US); CATHERINE R. MULZER, CIRCLEVILLE, OH (US); BENJAMIN D. NAAB, MARLBOROUGH, MA (US); ZUHRA I. NIAZIMBETOVA, MARLBOROUGH, MA (US); MARY REINTHAL, WILMINGTON, DE (US); PATRICIA TAINTOR, MARLBOROUGH, MA (US)

(21) Appl. No.: 18/897,545

(22) Filed: Sep. 26, 2024

Related U.S. Application Data
(60) Provisional application No. 63/587,545, filed on Oct. 3, 2023.

(51) Int. Cl. C08J 7/04; C08K 3/02; C25D 3/38

(52) U.S. Cl. CPC C08J 7/0423; C08K 3/02; C25D 3/38; C08J 2379/08; C08K 2201/001

(57) ABSTRACT

In a first aspect, a clad includes a polymer film and a first metal layer adhered to the polymer film. The polymer film includes an electrically conductive filler and has a surface resistivity of 1 Megaohm/square or less. The first metal layer has a thickness of 100 μm or less. The clad has less than 15 ppm of Pd. The metal layer is formed on the polymer film by directly electrochemically depositing the first metal layer on the polymer film.

### FIELD OF DISCLOSURE

The field of this disclosure is clads having polymer films and metal layers.

### BACKGROUND OF THE DISCLOSURE

Flexible copper clads (FCCs) are required for a wide variety of applications including circuits in consumer electronics, electromagnetic shielding film, battery current collectors, and resistive heaters for wind turbines. Typically, polyimide films that are used for the FCCs are metallized using lamination, a cast on copper process, or the deposition of a seed layer followed by electrolytic metallization. As these applications evolve, they require thinner dielectrics and copper to either provide finer lines and spaces of circuitry, shrink the overall dimensions of the device, or reduce the weight of the device. Using a conductive seed layer followed by electrolytic metallization is an effective way of depositing thin copper since the technique allows for copper to be deposited at any thickness. However, seed layer deposition can be expensive, or alter the electronic properties of the clad.

Metal-clad laminates, such as copper-clad laminates, are used in electronic devices for a variety of electronic components for flexible circuits, as well as for circuit packaging. Copper-clad laminates based on polyimide films are typically prepared by either lamination for metal thicknesses of greater than 5 m or sputtering for metal thicknesses of less than 5 m. Plating (e.g., electrochemical plating or electroless plating) is an alternative method to produce laminates that has received some attention, but it is not widely used to produce laminates with less than 5 m copper thickness. In addition, it is generally accepted that the reliability of plated polyimide copper laminates is below customer standards for electronic devices.

Metal-clad laminates produced by plating have traditionally had poor thermal reliability relative to metal clad produced by sputtering or lamination of copper foils. The highest reliability plated laminates have used electroless nickel seed layers. Adhesion between plated copper and polyimide films is challenging because of the presence of volatiles in the film, the degradation of the film surface by plating chemistry, and the use of film materials that lack functionality for strong chemical bonding to copper among other factors.

Additionally, during the operation of electronic devices, electric and magnetic fields are generated by the electronic components in the device, which can interfere with the operation of other electronic components in the same device or other nearby devices. This phenomenon is termed Electro-Magnetic Interference (EMI). Metals are commonly used for EMI shielding due to their high electrical conductivity which enables them to absorb EMI waves. The degree of shielding effectiveness is not a constant for each shielding material but is affected by the frequency of the incoming signal. The shielding effectiveness is determined by: a) the electrical conductivity of the shield; b) the thickness, uniformity, and smoothness of the shield; c) the physical properties of the shield; d) the frequency and impedance of the impinging field; and e) the magnetic permeability of the material. A need also exists for thin shielding films which include a thin metal layer for EMI shielding of electronic components.

### DETAILED DESCRIPTION

In a first aspect, a clad includes a polymer film and a first metal layer adhered to the polymer film. The polymer film includes an electrically conductive filler and has a surface resistivity of 1 Megaohm/square or less. The first metal layer has a thickness of 100 μm or less. The clad has less than 15 ppm of Pd. The metal layer is formed on the polymer film by directly electrochemically depositing the first metal layer on the polymer film.

Polymer films adhered to metal layers can be used to form clads. In one embodiment, useful polymer compositions for polymer films can include polyimides (PI), poly(amide-imides) (PAI), poly(ester-imides), poly(amide-ester-imides), polycarbonates (PC), polyethylene naphthalates (PEN), polystyrenes (PS), poly(methylmethacrylates) (PMMA) polyethylene terephthalates (PET), polyethylene terephthalate glycols (PETG), poly cyclohexylenedimethylene terephthalate glycols (PCTG), polyether imides (PEI), polysulfones, polyether sulfones, polyarylsulfones, polyaryletherketone (PAEK) such as polyether ether ketone (PEEK) and polyetherketoneketone (PEKK), and cyclic olefin copolymers. In one embodiment, polymer compositions having an imide group are particularly useful. Polymer compositions having an imide group and containing aromatic monomers are typically very thermally, chemically and electrochemically stable at the low (anodic) and high (cathodic) potentials used in lithium-ion batteries.

Depending upon context, “diamine” as used herein is intended to mean: (i) the unreacted form (i.e., a diamine monomer); (ii) a partially reacted form (i.e., the portion or portions of an oligomer or other polymer precursor derived from or otherwise attributable to diamine monomer) or (iii) a fully reacted form (the portion or portions of the polymer derived from or otherwise attributable to diamine monomer). The diamine can be functionalized with one or more moieties, depending upon the particular embodiment selected in the practice of the present invention.

Indeed, the term “diamine” is not intended to be limiting (or interpreted literally) as to the number of amine moieties in the diamine component. For example, (ii) and (iii) above include polymeric materials that may have two, one, or zero amine moieties. Alternatively, the diamine may be functionalized with additional amine moieties (in addition to the amine moieties at the ends of the monomer that react with dianhydride to propagate a polymeric chain). Such additional amine moieties could be used to crosslink the polymer or to provide other functionality to the polymer.

Similarly, the term “dianhydride” as used herein is intended to mean the component that reacts with (is complimentary to) the diamine and in combination is capable of reacting to form an intermediate (which can then be cured into a polymer). Depending upon context, “anhydride” as used herein can mean not only an anhydride moiety per se, but also a precursor to an anhydride moiety, such as: (i) a pair of carboxylic acid groups (which can be converted to anhydride by a de-watering or similar-type reaction); or (ii) an acid halide (e.g., chloride) ester functionality (or any other functionality presently known or developed in the future which is) capable of conversion to anhydride functionality.

Depending upon context, “dianhydride” can mean: (i) the unreacted form (i.e. a dianhydride monomer, whether the anhydride functionality is in a true anhydride form or a precursor anhydride form, as discussed in the prior above paragraph); (ii) a partially reacted form (i.e., the portion or portions of an oligomer or other partially reacted or precursor polymer composition reacted from or otherwise attributable to dianhydride monomer) or (iii) a fully reacted form (the portion or portions of the polymer derived from or otherwise attributable to dianhydride monomer).

The dianhydride can be functionalized with one or more moieties, depending upon the particular embodiment selected in the practice of the present invention. Indeed, the term “dianhydride” is not intended to be limiting (or interpreted literally) as to the number of anhydride moieties in the dianhydride component. For example, (i), (ii) and (iii) (in the paragraph above) include organic substances that may have two, one, or zero anhydride moieties, depending upon whether the anhydride is in a precursor state or a reacted state. Alternatively, the dianhydride component may be functionalized with additional anhydride type moieties (in addition to the anhydride moieties that react with diamine to provide a polymer). Such additional anhydride moieties could be used to crosslink the polymer or to provide other functionality to the polymer.

Any one of a number of polymer manufacturing processes may be used to prepare polymer films. It would be impossible to discuss or describe all possible manufacturing processes useful in the practice of the present invention. It should be appreciated that the monomer systems of the present invention are capable of providing the above-described advantageous properties in a variety of manufacturing processes. The compositions of the present invention can be manufactured as described herein and can be readily manufactured in any one of many (perhaps countless) ways of those of ordinarily skilled in the art, using any conventional or non-conventional manufacturing technology.

Although methods and materials similar or equivalent to those described herein can be used in the practice or testing of the present invention, suitable methods and materials are described herein.

When an amount, concentration, or other value or parameter is given as either a range, preferred range or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

In describing certain polymers, it should be understood that sometimes applicants are referring to the polymers by the monomers used to make them or the amounts of the monomers used to make them. While such a description may not include the specific nomenclature used to describe the final polymer or may not contain product-by-process terminology, any such reference to monomers and amounts should be interpreted to mean that the polymer is made from those monomers or that amount of the monomers, and the corresponding polymers and compositions thereof.

The materials, methods, and examples herein are illustrative only and, except as specifically stated, are not intended to be limiting.

As used herein, the terms “comprises,” “comprising,” “includes,” “including,” “has,” “having” or any other variation thereof, are intended to cover a non-exclusive inclusion. For example, a method, process, article, or apparatus that comprises a list of elements is not necessarily limited only those elements but may include other elements not expressly listed or inherent to such method, process, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, use of the “a” or “an” are employed to describe elements and components of the invention. This is done merely for convenience and to give a general sense of the invention. This description should be read to include one or at least one and the singular also includes the plural unless it is obvious that it is meant otherwise.

It will be understood that although the terms first, second, third, etc. may be used herein to describe various elements, components, regions, layers and/or sections, these elements, components, regions, layers, and/or sections should not be limited by these terms. These terms are only used to distinguish one element, component, region, layer and/or section from another element, component, region, layer and/or section. Thus, a first element, component, region, layer and/or section could be termed a second element, component, region, layer and/or section without departing from the teachings of the present invention. Similarly, the terms “top” and “bottom” are only relative to each other. It will be appreciated that when an element, component, layer or the like is inverted, what is the “bottom” before being inverted would be the “top” after being inverted, and vice versa. When an element is referred to as being “on” or “disposed on” another element, it means positioning on or below the object portion, but does not essentially mean positioning on the upper side of the object portion based on a gravity direction, and it can be directly on the other element or intervening elements may be present therebetween. In contrast, when an element is referred to as being “directly on” or “disposed directly on” another element, there are no intervening elements present.

Further, it will also be understood that when one element, component, region, layer and/or section is referred to as being “between” two elements, components, regions, layers and/or sections, it can be the only element, component, region, layer and/or section between the two elements, components, regions, layers and/or sections, or one or more intervening elements, components, regions, layers and/or sections may also be present.

### Organic Solvents

Useful organic solvents for the synthesis of polymers of the present invention are preferably capable of dissolving the polymer precursor materials. Such a solvent should also have a relatively low boiling point, such as below 225° C., so the polymer can be dried at moderate (i.e., more convenient and less costly) temperatures. A boiling point of less than 210, 205, 200, 195, 190, or 180° C. is preferred.

Useful organic solvents include: N-methylpyrrolidone (NMP), dimethylacetamide (DMAc), methyl ethyl ketone (VEK), N,N′-dimethyl-formamide (DMF), dimethyl sulfoxide (DMSO), tetramethyl urea (TMU), glycol ethyl ether, diethyleneglycol diethyl ether, 1,2-dimethoxyethane (monoglyme), diethylene glycol dimethyl ether (diglyme), 1,2-bis-(2-methoxyethoxy) ethane (triglyme), gamma-butyrolactone, and bis-(2-methoxyethyl) ether, tetrahydrofuran (THF), ethyl acetate, hydroxyethyl acetate glycol monoacetate, acetone and mixtures thereof. In one embodiment, preferred solvents include N-methylpyrrolidone (NMP) and dimethylacetamide (DMAc).

### Diamines

In one embodiment, an aromatic diamine can be used for forming a polymer having an imide group. Aromatic diamines can include fluorinated aromatic diamines, such as 2,2′-bis(trifluoromethyl)benzidine (TFMB), 2,2′-bis-(4-aminophenyl)hexafluoropropane, 4,4′-diamino-2,2′-trifluoromethyldiphenyloxide, 3,3′-diamino-5,5′-trifluoromethyldiphenyloxide, 9,9′-bis(4-aminophenyl)fluorene, 4,4′-trifluoromethyl-2,2′-diaminobiphenyl, 4,4′-oxy-bis[2-trifluoromethyl)benzeneamine](1,2,4-OBABTF), 4,4′-oxy-bis[3-trifluoromethyl)benzeneamine], 4,4′-thiobis[(2-trifluoromethyl)benzeneamine], 4,4′-thiobis[(3-trifluoromethyl)benzeneamine], 4,4′-sulfoxyl-bis[(2-trifluoromethyl)benzeneamine, 4,4′-sulfoxyl-bis[(3-trifluoromethyl)benzeneamine], 4,4′-keto-bis[(2-trifluoromethyl)benzeneamine], 1,1-bis[4′-(4″-amino-2″-trifluoromethylphenoxy)phenyl]cyclopentane, 1,1-bis[4′-(4″-amino-2″-trifluoromethylphenoxy)phenyl]cyclohexane, 2-trifluoromethyl-4,4′-diaminodiphenylether; 1,4-(2′-trifluoromethyl-4′,4″-diaminodiphenoxy)benzene, 1,4-bis(4′-aminophenoxy)-2-[(3′,5′-ditrifluoromethyl)phenyl]benzene (6F-amine), 1,4-bis[2′-cyano-3′(“4-amino phenoxy)phenoxy]-2-[(3′,5′-ditrifluoro-methyl)phenyl]benzene (6FC-diamine), 3,5-diamino-4-methyl-2′,3′,5′,6′-tetrafluoro-4′-tri-fluoromethyldiphenyloxide, 2,2-bis[4(4-aminophenoxy)phenyl]phthalein-3′,5′-bis(trifluoromethyl)anilide (6FADAP) and 3,3′,5,5′-tetrafluoro-4,4′-diamino-diphenylmethane (TFDAM).

Other useful diamines can include 4,4′-diaminobiphenyl, 4,4″-diaminoterphenyl, 4,4′-diaminobenzanilide (DABA), 4,4′-diaminophenylbenzoate, 4,4′-diaminobenzophenone, 4,4′-diaminodiphenylmethane (MDA), 4,4′-diaminodiphenylsulfide, 4,4′-diaminodiphenylsulfone, 3,3′-diaminodiphenylsulfone, bis[4-(4-aminophenoxy)phenyl]sulfone (BAPS), 4,4′-bis(4-aminophenoxy)biphenyl (BAPB), 4,4′-diaminodiphenylether (ODA), 3,4′-diaminodiphenylether, 4,4′-isopropylidenedianiline, 2,2′-bis(3-aminophenyl)propane, 2,2-bis(4-aminophenyl)propane, 3,3′-dimethyl-4,4′-diaminobiphenyl, 4-aminophenyl-3-aminobenzoate, bis(p-beta-amino-t-butylphenyl)ether, p-bis-2-(2-methyl-4-aminopentyl)benzene. In one embodiment, the diamine is a triamine, such as N,N-bis(4-aminophenyl)-n-butylamine, N,N-bis(4-aminophenyl)methylamine or N,N-bis(4-aminophenyl)aniline.

Other useful diamines can include 1,2-bis(4-aminophenoxy)benzene, 1,3-bis(4-aminophenoxy)benzene (RODA), 1,2-bis(3-aminophenoxy)benzene, 1,3-bis(3-aminophenoxy)benzene, 1-(4-aminophenoxy)-3-(3-aminophenoxy)benzene, 1,4-bis-(4-aminophenoxy)benzene, 1,4-bis(3-aminophenoxy)benzene, 1-(4-aminophenoxy)-4-(3-aminophenoxy)benzene, 2,2-bis(4-[4-aminophenoxy]phenyl)propane (BAPP), 2,2′-bis(4-phenoxyaniline)isopropylidene.

Other useful diamines can include p-phenylenediamine (PPD), m-phenylenediamine (MPD), 2,5-dimethyl-1,4-diaminobenzene, 2,5-dimethyl-1,4-phenylenediamine (DPX), 1,4-naphthalenediamine, 1,5-naphthalenediamine, 1,5-diaminonaphthalene, m-xylylenediamine, and p-xylylenediamine.

Other useful diamines for forming polymers having an imide group can include an aliphatic diamine, such as 1,2-diaminoethane, 1,6-diaminohexane (HMD), 1,4-diaminobutane, 1,5 diaminopentane, 1,7-diaminoheptane, 1,8-diaminooctane, 1,9-diaminononane, 1,10-diaminodecane (DMD), 1,11-diaminoundecane, 1,12-diaminododecane (DDD), 1,16-hexadecamethylenediamine, 1,3-bis(3-aminopropyl)-tetramethyldisiloxane, trans-1,4-diaminocyclohexane (CHDA), isophoronediamine (IPDA), bicyclo[2.2.2]octane-1,4-diamine and combinations thereof. Other aliphatic diamines suitable for practicing the invention include those having six to twelve carbon atoms or a combination of longer chain and shorter chain diamines so long as both developability and flexibility of the polymer are maintained. Long chain aliphatic diamines may increase flexibility.

Other useful diamines for forming a polymer having an imide group can include an alicyclic diamine (can be fully or partially saturated), such as a cyclobutane diamine (e.g., cis- and trans-1,3-diaminocyclobutane, 6-amino-3-azaspiro[3.3]heptane, and 3,6-diaminospiro[3.3]heptane), bicyclo[2.2.1]heptane-1,4-diamine, isophoronediamine, and bicyclo[2.2.2]octane-1,4-diamine. Other alicyclic diamines can include cis-1,4-cyclohexanediamine, trans-1,4-cyclohexanediamine, 1,4-bis(aminomethyl)cyclohexane, 4,4′-methylenebis(cyclohexylamine), 4,4′-methylenebis(2-methyl-cyclohexylamine), bis(aminomethyl)norbornane.

### Dianhydrides

In one embodiment, aromatic dianhydrides can be used for forming a polymer having an imide group. The dianhydrides can be used in their tetra-acid form (or as mono, di, tri, or tetra esters of the tetra acid), or as their diester acid halides (chlorides). However, in some embodiments, the dianhydride form can be preferred, because it is generally more reactive than the acid or the ester.

Examples of suitable aromatic dianhydrides include 3,3′,4,4′-biphenyltetracarboxylic dianhydride (BPDA), 2-(3′,4′-dicarboxyphenyl)-5,6-dicarboxybenzimidazole dianhydride, 2-(3′,4′-dicarboxyphenyl)-5,6-dicarboxybenzoxazole dianhydride, 2-(3′,4′-dicarboxyphenyl)-5,6-dicarboxybenzothiazole dianhydride, 2,2′,3,3′-benzophenonetetracarboxylic dianhydride, 2,3,3′,4′-benzophenonetetracarboxylic dianhydride, 3,3′,4,4′-benzophenonetetracarboxylic dianhydride (BTDA), 2,2′,3,3′-biphenyltetracarboxylic dianhydride, 2,3,3′,4′-biphenyltetracarboxylic dianhydride, 4,4′-thio-diphthalic anhydride, bis(3,4-dicarboxyphenyl)sulfone dianhydride, bis(3,4-dicarboxyphenyl)sulfoxide dianhydride (DSDA), bis(3,4-dicarboxyphenyloxadiazole-1,3,4)-p-phenylene dianhydride, bis(3,4-dicarboxyphenyl)-2,5-oxadiazole-1,3,4-dianhydride, bis(3′,4′-dicarboxydiphenylether)-2,5-oxadiazole-1,3,4-dianhydride, 4,4′-oxydiphthalic anhydride (ODPA), bis(3,4-dicarboxyphenyl)thioether dianhydride, bisphenol A dianhydride (BPADA), bisphenol S dianhydride, bis-1,3-isobenzofurandione, 1,4-bis(4,4′-oxyphthalic anhydride)benzene, bis(3,4-dicarboxyphenyl)methane dianhydride, perylene-3,4,9,10-tetracarboxylic dianhydride, 1,3-bis-(4,4′-oxydiphthalic anhydride)benzene, 2,2-bis(3,4-dicarboxyphenyl)propane dianhydride, 4,4′-(hexafluoroisopropylidene)diphthalic anhydride (6FDA) and 9,9-bis(trifluoromethyl)-2,3,6,7-xanthenetetracarboxylic dianhydride.

Other useful dianhydrides can include 1,2,5,6-naphthalenetetracarboxylic dianhydride, 1,4,5,8-naphthalenetetracarboxylic dianhydride, 2,3,6,7-naphthalenetetracarboxylic dianhydride, bicyclo-[2,2,2]-octen-(7)-2,3,5,6-tetracarboxylic-2,3,5,6-dianhydride, cyclopentadienyltetracarboxylic dianhydride, ethylenetetracarboxylic dianhydride, pyromellitic dianhydride (PMDA), tetrahydrofurantetracarboxylic dianhydride, 2,6-dichloronaphthalene-1,4,5,8-tetracarboxylic dianhydride, 2,7-dichloronaphthalene-1,4,5,8-tetracarboxylic dianhydride, 2,3,6,7-tetrachloronaphthalene-1,4,5,8-tetracarboxylic dianhydride, phenanthrene-1,8,9,10-tetracarboxylic dianhydride, pyrazine-2,3,5,6-tetracarboxylic dianhydride, benzene-1,2,3,4-tetracarboxylic dianhydride and thiophene-2,3,4,5-tetracarboxylic dianhydride.

In one embodiment, dianhydrides for forming a polymer with an imide group can include alicyclic dianhydrides, such as cyclobutane-1,2,3,4-tetracarboxylic diandydride (CBDA), 1,2,4,5-cyclohexanetetracarboxylic dianhydride, 1,2,3,4-cyclohexanetetracarboxylic dianhydride, 1,2,3,4-tetramethyl-1,2,3,4-cyclobutanetetracarboxylic dianhydride, 1,2,3,4-cyclopentanetetracarboxylic dianhydride (CPDA), hexahydro-4,8-ethano-1H,3H-benzo[1,2-c:4,5-c′]difuran-1,3,5,7-tetrone (BODA), 3-(carboxymethyl)-1,2,4-cyclopentanetricarboxylic 1,4:2,3-dianhydride (TCA), and meso-butane-1,2,3,4-tetracarboxylic dianhydride.

In one embodiment, wherein the polymer further includes aromatic amide components, a suitable additional dicarbonyl chloride for forming the polymer can include terephthaloyl chloride (TPCI), isophthaloyl chloride (IPCI), biphenyl dicarbonyl chloride (BPCI), naphthalene dicarbonyl chloride, terphenyl dicarbonyl chloride, 2-fluoro-terephthaloyl chloride and trimellitic anhydride.

In one embodiment, poly(amide-ester-imides) can be produced from polyols which can react with carboxylic acid or the ester acid halides to generate ester linkages.

The dihydric alcohol component may be almost any alcoholic diol containing two esterifiable hydroxyl groups. Mixtures of suitable diols may also be included. Suitable diols for use herein include for example, ethylene glycol, propylene glycol, 1,4-butanediol, 1,5-pentanediol, neopentyl glycol, etc.

The polyhydric alcohol component may be almost any polyhydric alcohol containing at least 3 esterifiable hydroxyl groups in order to provide the above-described synthesis process advantages of this invention. Mixtures of such polyhydric alcohols may suitably be employed. Suitable polyhydric alcohols include, for example, tris(2-hydroxyethyl)isocyanurate, glycerin, 1,1,1-trimethylolethane, 1,1,1-trimethylolpropane, and their mixtures.

In some cases, useful diamine and dianhydride monomers contain ester groups. Examples of these monomers include diamines, such as 4-aminophenyl-4-aminobenzoate and 4-amino-3-methylphenyl-4-aminobenzoate, and dianhydrides, such as p-phenylene bis(trimellitate) dianhydride.

In some cases, useful diamine and dianhydride monomers contain amide groups. Examples of these monomers include diamines, such as 4,4′-diaminobenzamide (DABAN), and dianhydrides, such as N,N′-(2,2′-bis(trifluoromethyl)-[1,1′-biphenyl]-4,4′-diyl)bis(1,3-dioxo-1,3-dihydroisobenzofuran-5-carboxamide) and N,N′-(9H-fluoren-9-ylidenedi-4,1-phenylene)bis[1,3-dihydro-1,3-dioxo-5-isobenzofurancarboxamide].

Higher order copolymers having an imide group can include any of the monomers described above.

### Imidization Catalysts

In one embodiment, an imidization catalyst (sometimes called an “imidization accelerator”) can be used as a conversion chemical that can help lower the imidization temperature for forming a polymer having an imide group and shorten the imidization time. The polyamic acid casting solutions of the present invention comprises both a polyamic acid solution combined with some amount of conversion chemicals. The conversion chemicals found to be useful in the present invention include, but are not limited to, (i) one or more dehydrating agents and/or co-catalysts, such as, aliphatic acid anhydrides (acetic anhydride, trifluoroacetic anhydride, propionic anhydride, monochloroacetic anhydride, bromo adipic anhydride, etc.) and aromatic acid anhydrides; and (ii) one or more imidization catalysts, such as, aliphatic tertiary amines (triethylamine, etc.), aromatic tertiary amines (dimethylaniline, N,N-dimethyl benzylamine, etc.) and heterocyclic tertiary amines (pyridine, alpha, beta, gamma, picoline, 3,5-lutidine, 3,4-lutidene, isoquinoilne, etc.) and guanidines (e.g. tetramethylguanidine). In one embodiment, an imidization catalyst does not include a diazole. Other useful dehydrating agents can include diacetyl oxide, butyryl oxide, benzoyl oxide, 1,3-dichlorohexyl carbodiimide, N, N-dicyclohexyl carbodiimide, benzenesulfonyl chloride, thionyl chloride and phosphorus pentachloride. In some embodiments, the dehydrating agent can also act as a catalyst to enhance the reaction kinetics for the imidization. The anhydride dehydrating material is typically used in a slight molar excess of the amount of amide acid groups present in the polyamic acid solution. In one embodiment, the amount of dehydrating agent used is typically about 2.0 to 4.0 moles per equivalent of the polyamic acid formula unit. Generally, a comparable amount of tertiary amine catalyst is used. The ratio of these catalysts and their concentration in the polyamic acid solution will influence imidization kinetics and the film properties. Polymer films can have imidization catalysts present in the polymer film in an amount in the range of from 1 part per billion (ppb) to 1 wt %, from 10 ppb to 0.1 wt %, or from 100 ppb to 0.01 wt %.

### Electrically Conductive Fillers

In one embodiment, electrically conductive fillers can include metals (such as gold, silver, copper, etc.), conducting mixed-metal oxides (such as cuprates, superconducting oxides, indium tin oxide, antimony tin oxide, mixed titanium/tin/zirconium oxides, etc.), organic compounds, such as polyaniline, polythiophene, polypyrrole, polyphenylenevinylene, polydialkylfluorenes, carbon black, graphite, graphene, multiwalled and single walled carbon nanotubes, and other nanotube structures, and carbon nanofibers. In one embodiment, an electrically conductive filler can be an inorganic filler, an organic filler or a mixture thereof.

In one embodiment, an electrically conductive filler is carbon black. In one embodiment, the electrically conductive filler is selected from the group consisting of acetylene blacks, super abrasion furnace blacks, conductive furnace blacks, conductive channel type blacks, carbon nanotubes, carbon fibers, fine thermal blacks and mixtures thereof. For carbon black, oxygen complexes on the surface of the carbon particles act as an electrically insulating layer. Thus, low volatility content is generally desired for high conductivity. However, it is also necessary to consider the difficulty of dispersing the carbon black. Surface oxidation enhances deagglomeration and dispersion of carbon black. In some embodiments, when the electrically conductive filler is carbon black, the carbon black has a volatile content less than or equal to 1%.

### Other Fillers

In one embodiment, other fillers for a polymer film can include other inorganic and organic fillers not described above for electrically conductive fillers. Inorganic fillers can include thermally conductive fillers, such as metal oxides, inorganic nitrides and metal carbides. In one embodiment inorganic fillers can include diamond, clay, talc, sepiolite, mica, dicalcium phosphate, metal oxides, including magnetic metal oxides, transparent conducting oxides and fumed metal oxides. In one embodiment, inorganic fillers can include inorganic oxides, such as oxides of silicon, aluminum, zinc and titanium, hollow (porous) silicon oxide, antimony oxide, zirconium oxide, indium tin oxide, antimony tin oxide, mixed titanium/tin/zirconium oxides, and binary, ternary, quaternary and higher order oxides of one or more cations selected from silicon, titanium, aluminum, antimony, zirconium, indium, tin, zinc, niobium and tantalum. In one embodiment, particle composites (e.g., single or multiple core/shell structures) can be used, in which one oxide encapsulates another oxide in one particle.

In one embodiment, inorganic fillers can include other ceramic compounds, such as boron nitride, aluminum nitride, ternary or higher order compounds containing boron, aluminum and nitrogen, gallium nitride, silicon nitride, aluminum nitride, zinc selenide, zinc sulfide, zinc telluride, silicon carbide, and their combinations, or higher order compounds containing multiple cations and multiple anions and can include oxycarbides and oxynitrides.

In one embodiment, fillers for a polymer film can have a median particle size, d₅₀, in a range of from 0.1 to 10 μm, from 0.1 to 5 μm, from 0.2 to 5 μm, or from 0.2 to 3 μm. Filler size can be determined using a laser particle size analyzer, with the filler dispersed in an organic solvent (optionally with the aid of a dispersant, adhesion promoter, and/or coupling agent). The median particle size, d₅₀, is the equivalent spherical diameter based on a median volume distribution of the particles. If the median particle size is smaller than 0.1 μm, the filler particles can tend to agglomerate, or become unstable, in the organic solvents used in polymer manufacturing. If the median particle size of the agglomerated particles exceeds 10 μm the dispersion of the filler component in the polymer film may be too non-homogeneous (or unsuitably large for the thickness of the film). A relatively non-homogenous dispersion of the filler component in the film can result in poor mechanical elongation of the film, poor flex life of the film, and/or low dielectric strength. In one embodiment, fillers may require extensive milling and filtration to breakup unwanted particle agglomeration as is typical when attempting to disperse some fillers into a polymer matrix. Such milling and filtration can be costly and may not be capable of removing all unwanted agglomerates. In one embodiment, the average aspect ratio of the filler can be 1 or greater. In some embodiments, the filler is selected from the group consisting of needle-like fillers (acicular), fibrous fillers, platelet fillers, polymer fibers, and mixtures thereof. In one embodiment, the fillers can have an aspect ratio of at least 1, at least 2, at least 4, at least 6, at least 8, at least 10, at least 12, at least 15, at least 25, at least 50, at least 100, at least 200, or at least 300 to 1.

In one embodiment, the filler includes a mixture, or blend, of fillers having any number of particle types, particle sizes and particle shapes, wherein a mixture, or blend, can be of the same type of filler or a different type of filler.

In one embodiment, fillers can be coated with a coupling agent. For example, a filler particle can be coated with an aminosilane, phenylsilane, acrylic or methacrylic coupling agents derived from the corresponding alkoxysilanes. Trimethylsilyl surface capping agents can be introduced to the particle surface by reaction of the fillers with hexamethyldisilazane. In one embodiment, fillers can be coated with a dispersant. In one embodiment, fillers can be coated with a combination of a coupling agent and a dispersant. Alternatively, the coupling agent, dispersant or a combination thereof can be incorporated directly into the polymer film and not necessarily coated onto the fillers.

### Polymer Films

In one embodiment, a polymer film that is a polyimide film can be produced by combining a diamine and a dianhydride (monomer or other polyimide precursor form) together with a solvent to form a polyamic acid (also called a polyamide acid) solution. The dianhydride and diamine can be combined in a molar ratio of about 0.90 to 1.10. The molecular weight of the polyamic acid formed therefrom can be adjusted by adjusting the molar ratio of the dianhydride and diamine.

In one embodiment, a polyamic acid casting solution is derived from the polyamic acid solution. The polyamic acid casting solution, and/or the polyamic acid solution, are combined with conversion chemicals like: (i) one or more dehydrating agents, such as, aliphatic acid anhydrides (acetic anhydride, etc.) and/or aromatic acid anhydrides; and (ii) one or more catalysts, such as, aliphatic tertiary amines (triethyl amine, etc.), aromatic tertiary amines (dimethyl aniline, etc.) and heterocyclic tertiary amines (pyridine, picoline, isoquinoline, etc.). The anhydride dehydrating material it is often used in molar excess compared to the amount of amide acid groups in the polyamic acid. The amount of acetic anhydride used is typically about 2.0 to 4.0 moles per equivalent (repeat unit) of polyamic acid. Generally, a comparable amount of tertiary amine catalyst is used. Fillers, dispersed or suspended in solvent as described above, are then added to the polyamic acid solution.

In one embodiment, the polyamic acid solution is dissolved in an organic solvent at a concentration from about 5.0 or 10 percent to 15, 20, 25, 30, 35 or 40 percent by weight. In one embodiment, a slurry comprising an electrically conductive filler is prepared, where the slurry has an electrically conductive filler content in a range of from 0.1 to 70, from 0.5 to 60, from 1 to 55, from 2 to 50, or from 5 to 45 percent by weight. The slurries may or may not be milled using a ball mill to reach the desired particle size. The slurries may or may not be filtered to remove any residual large particles. A polyamic acid solution can be made by methods well known in the art. The polyamic acid solution may or may not be filtered. In some embodiments, the solution is mixed in a high shear mixer with the filler slurry. When a polyamic acid solution is made with a slight excess of diamine, additional dianhydride solution may or may not be added to increase the viscosity of the mixture to the desired level for film casting. The amount of the polyamic acid solution, and filler slurry can be adjusted to achieve the desired loading levels in the cured film. In some embodiments, the mixture is cooled below 10° C. and mixed with conversion chemicals prior to casting.

The solvated mixture (the polyamic acid casting solution) can then be cast or applied onto a support, such as an endless belt or rotating drum, to give a partially imidized gel film. Alternatively, it can be cast on a polymeric carrier such as PET, other forms of Kapton® polyimide film (e.g., Kapton® HN or Kapton® E films) or other polymeric carriers. The gel film may be stripped from the drum or belt, placed on a tenter frame, and cured in an oven, using convective and radiant heat to remove solvent and complete the imidization to greater than 98% solids level. The film can then be separated from the support, oriented such as by tentering, with continued heating (drying and curing) to provide a polyimide film.

Useful methods for producing polyimide films can be found in U.S. Pat. Nos. 5,166,308 and 5,298,331, which are incorporate by reference into this specification for all teachings therein. Numerous variations are also possible, such as,
(a) A method wherein the diamine components and dianhydride components are preliminarily mixed together and then the mixture is added in portions to a solvent while stirring.
(b) A method wherein a solvent is added to a stirring mixture of diamine and dianhydride components. (contrary to (a) above)
(c) A method wherein diamines are exclusively dissolved in a solvent and then dianhydrides are added thereto at such a ratio as allowing to control the reaction rate.
(d) A method wherein the dianhydride components are exclusively dissolved in a solvent and then amine components are added thereto at such a ratio to allow control of the reaction rate.
(e) A method wherein the diamine components and the dianhydride components are separately dissolved in solvents and then these solutions are mixed in a reactor.
(f) A method wherein the polyamic acid with excessive amine component and another polyamic acid with excessive dianhydride component are preliminarily formed and then reacted with each other in a reactor, particularly in such a way as to create a non-random or block copolymer.
(g) A method wherein a specific portion of the amine components and the dianhydride components are first reacted and then the residual diamine components are reacted, or vice versa.
(h) A method wherein the conversion chemicals (catalysts) are mixed with the polyamic acid to form a polyamic acid casting solution and then cast to form a gel film.
(i) A method wherein the components are added in part or in whole in any order to either part or whole of the solvent, also where part or all of any component can be added as a solution in part or all of the solvent.
(j) A method of first reacting one of the dianhydride components with one of the diamine components giving a first polyamic acid. Then reacting another dianhydride component with another amine component to give a second polyamic acid. Then combining the amic acids in any one of a number of ways prior to film formation.

In one embodiment, the solvated mixture (the polyamic acid casting solution) can be mixed with a crosslinking precursor and then cast to form a polymer film. In one embodiment, a polymer film contains a crosslinked polymer in a range of from 80 to 99 wt %. In some embodiments, the polymer film contains between and including any two of the following: 80, 85, 90, 95 and 99 wt % crosslinked polymer. In yet another embodiment, the polymer film contains 91 to 98 wt % crosslinked polymer.

In one embodiment, a crosslinking reaction includes chemical compounds, such as reactive amines, that can participate in a chemical reaction that crosslinks the polymer chains in the film. In one embodiment, heat may be used to crosslink the polymer. In one embodiment, irradiation with a light source may be used to crosslink the polymer through a photoinitiated process. In one embodiment, an additional reactive chemical species may be used to crosslink the polymer. In one embodiment, any combination of these processes may be used to crosslink the polymer.

Crosslinking of the polymer can be determined by a variety of methods. In one embodiment, the gel fraction of polymer may be determined by using an equilibrium swelling method, comparing the weight of a dried film before and after crosslinking. In one embodiment, a crosslinked polymer can have a gel fraction in the range of from 20 to 100%, from 40 to 100%, from 50 to 100%, from 70 to 100%, or from 85 to 100%. In one embodiment, the crosslinked network can be identified using rheological methods. An oscillatory time sweep measurement at specific strain, frequency, and temperature can be used to confirm the formation of crosslinked network. Initially, the loss modulus (G″) value is higher than the storage modulus (G′) value, indicating that the polymer solution behaves like a viscous liquid. Over time, the formation of a crosslinked polymer network is evidenced by the crossover of G′ and G″ curves. The crossover, referred to as the “gel point”, represents when the elastic component predominates over the viscous.

In one embodiment, electrically conductive filler is first dispersed in a solvent to form a slurry. The slurry is then dispersed in the polyamic acid solution. In one embodiment, the concentration of electrically conductive filler to polyimide (in the final film) is in the range of from 5 to 65 wt %, from 5 to 50 wt %, from 10 to 40 wt %, or from 15 to 35 wt % based on the total weight of the polymer film. In one embodiment, the concentration of electrically conductive filler to polyimide (in the final film) is at least 5, at least 10, at least 15, at least 20, or at least 25 wt % based on the total weight of the polymer film. The composition of the cured film can be calculated from the composition of the components in the mixtures, excluding DMAc solvent (which is removed during curing) and accounting for removal of water during conversion of polyamic acid to polyimide. When using electrically conductive fillers, as the concentration of the filler increases, the conductivity of the polyimide film also increases. In one embodiment, an electrically conductive polymer film can have a surface resistivity of 1 Megaohm/square or less, 0.5 Megaohm/square or less, 0.1 Megaohm/square or less, or 50,000 ohm/square or less. Those skilled in the art will appreciate that in addition to loading levels, the characteristics of the electrically conductive filler, such as particle size, morphology, aspect ratio, surface oxidation, etc., will impact the surface resistivity of the polymer film containing them.

In one embodiment, blending of the filler slurry with a polyamic acid solution to form the filled polyamic acid casting solution is done using high sheer mixing. In this embodiment, if the filler is present beyond 65 weight percent in the final film, the film can be too brittle and may not be sufficiently flexible to form a freestanding, mechanically tough, flexible sheet. Moreover, if the filler is present at a level of less than 5 weight percent, the films formed therefrom may not be sufficiently conductive.

In one embodiment, the casting solution can further comprise any one of a number of additives, such as processing aids (e.g., oligomers), antioxidants, light stabilizers, flame retardant additives, anti-static agents, heat stabilizers, ultraviolet absorbing agents or various reinforcing agents.

In one embodiment, a coextrusion process can be used to form a multilayer polymer film having two or more layers, for example a three-layer polymer film with an inner core layer sandwiched between two outer layers. In this process, for a three-layer polyimide film, a finished polyamic acid solution is filtered and pumped to a slot die, where the flow is divided in such a manner as to form the first outer layer and the second outer layer of a three-layer coextruded film. In some embodiments, a second stream of polymer is filtered, then pumped to a casting die, in such a manner as to form the middle polymer core layer of a three-layer coextruded film. The flow rates of the solutions can be adjusted to achieve the desired layer thickness. In one embodiment, the polymer composition and filler content of the first and second outer layers are the same, while in another embodiment the polymer composition and/or filler content of the first and second outer layers are different. In some embodiments the polymer composition and filler content of the core layer can be the same or different than that of one or both of the outer layers.

In one embodiment, the multilayer film is prepared by simultaneously extruding the first outer layer, the core layer and the second outer layer. In some embodiments, the layers are extruded through a single or multi-cavity extrusion die. In another embodiment, the multilayer film is produced using a single-cavity die. If a single-cavity die is used, the laminar flow of the streams should be of high enough viscosity to prevent comingling of the streams and to provide even layering. In some embodiments, the multilayer film is prepared by casting from the slot die onto a moving stainless-steel belt. In one embodiment, for a polymer having an imide group, the belt is then passed through a convective oven, to evaporate solvent and partially imidize the polymer, to produce a “green” film. The green film can be stripped off the casting belt and wound up. The green film can then be passed through a tenter oven to produce a fully cured polymer film. In some embodiments, during tentering, shrinkage can be minimized by constraining the film along the edges (i.e., using clips or pins).

In one embodiment, the outer layers of the present invention can also be applied to the core layer during an intermediate manufacturing stage of making polymer film such as to gel film or to green film.

When forming an imide-containing polymer, the term “gel film” refers to a polyamic acid sheet, which is laden with volatiles, primarily solvent, to such an extent that the polyamic acid is in a gel-swollen, or rubbery condition, and may be formed in a chemical conversion process. The volatile content is usually in the range of 70 to 90% by weight and the polymer content usually in the range of 10 to 30% by weight of the gel film. The final film becomes “self-supporting” in the gel film stage. It can be stripped from the support on which it was cast and heated to a final curing temperature. The gel film generally has an amic acid to imide ratio between 10:90 and 50:50, most often 30:70.

The gel film structure can be prepared by the method described in U.S. Pat. No. 3,410,826. This patent discloses mixing a chemical converting agent and a catalyst, such as a lower fatty acid anhydride and a tertiary amine, into the polyamic-acid solution at a low temperature. This is followed by casting the polyamic-acid solution in film-form, onto a casting drum. The film is mildly heated after casting, at for example 100° C., to activate the conversion agent and catalyst in order to transform the cast film to a polyamic acid/polyimide gel film.

Another type of polymer film is a “green film” which, for a polyimide film, is partially polyamic acid and partially polyimide, and may be formed in a thermal conversion process. Green film contains generally about 50 to 75% by weight polymer and 25 to 50% by weight solvent. Generally, it should be sufficiently strong to be substantially self-supporting. Green film can be prepared by casting the polyamic acid solution into film form onto a suitable support such as a casting drum or belt and removing the solvent by mild heating at up to 150° C. A low proportion of amic acid units in the polymer, e.g., up to 25%, may be converted to imide units.

Application of the polymer films of the present invention can be accomplished in any number of ways. Such methods include using a slot die, dip coating, or kiss-roll coating a film followed by metering with doctor knife, doctor rolls, squeeze rolls, or an air knife. The coating may also be applied by brushing or spraying. By using such techniques, it is possible to prepare both one and two-sided coated laminates. In preparation of the two-side coated structures, one can apply the coatings to the two sides of a polymer either simultaneously or consecutively before going to the curing and drying stage of the polymer.

The thickness of the polymer film may be adjusted, depending on the intended purpose of the film or final application specifications. In one embodiment, the polymer film has a total thickness in a range of from 1 to 300 μm, from 2 to 200 μm, from 5 to 150 μm, from 10 to 100 μm, or from 20 to 80 μm.

In one embodiment, for a two-layer or three-layer polymer film, the core layer has a thickness in a range of from 0.75 to 225 μm, from 1.5 to 150 μm, from 3.75 to 112.5 μm, or from 7.5 to 75 μm and the outer layer(s) each have a thickness in a range of from 0.25 to 75 μm, from 0.5 to 50 μm, from 1.25 to 37.5 μm, or from 2.5 to 25 μm. In one embodiment, for a three-layer film, the thicknesses of the outer layers can be the same or different.

### Clads

In one embodiment, a clad can include a polymer film and a metal layer adhered to the polymer film. In one embodiment a clad can include a polymer film with metal layers adhered to both sides of the polymer film.

Clads can be formed as single-sided or double-sided clads by any number of well-known processes. In one embodiment, a metal plating process may be used to form a clad, such as a polyimide film. In one embodiment a polyimide film includes a thermoplastic polyimide layer. A metal layer can be formed on the thermoplastic polyimide layer of the polymer film by plating a metal layer. In one embodiment, a metal layer can be 100 μm or less, 50 μm or less, 25 μm or less, 10 μm or less, 5 μm or less, 3 μm or less, or 1 μm or less. By using a plating process to form metal layers on polymer films, smoother interfaces can be formed. Conventional lamination of metal foils to polymer films relies on surface roughness of the foils to provide good adhesion to the polymer film, but also may require roughnesses that are greater than the thickness of a thin metal layer.

In one embodiment, a polymer film may be bonded to a first metal layer in a plating process to form a single-sided clad. In one embodiment, the surface of the polymer film to be plated can be plasma treated before the metal layer is formed. Thus, a clad formed comprises the polymer film and a thin, conductive layer. In one embodiment, for a multilayer polymer film, using a thermoplastic polymer layer as an outer layer to bond to the metal layer enables strong adhesion between the polymer film and metal layer despite the smoothness of the interface between the layers, and without the use of additional primer or adhesive layers in between.

In one embodiment, a polymer film may be bonded to a first metal layer by directly electrochemically depositing a metal layer on a polymer film (direct metallization). The term “directly electrochemically depositing a metal layer” or “direct plating” on a polymer film means that an electrolytic plating process is used to form and build a metal layer on a polymer film without initially using an electroless plating or physical vapor deposition or chemical vapor deposition process to form an initial metal layer on the polymer film. Removing this seed layer from the process makes direct metallization faster and less costly than traditional methods for making copper clads. In one embodiment, the clad is substantially free of Pd. “Substantially free of Pd” is intended to mean that no significant amount of Pd is detectable in the clad when analyzed using inductively coupled plasma mass spectrometry (ICP-MS), as described below. Substantially free of Pd means that less than 15 ppm, less than 10 ppm, or less than 5 ppm of Pd is detectable. In some instances, trace quantities of Pd can be detected in the digested clad when using ICP-MS, even though no Pd catalyst was used in the metallization process. In the case of a process using a Pd catalyst, however, levels of Pd greater than 5 ppm, 10 ppm, or 15 ppm can be detected. For example, in a process using a Pd catalyst, 200 ppm of Pd metal might be used and can be detected in the clad using ICP-MS at levels of about 20 ppm.

In one embodiment, a polymer film may be bonded to first and second metal layers to form a double-sided clad. One or both of the metal layers can be formed using a plating process. In one embodiment, the surfaces of the polymer film to be plated can be plasma treated before the metal layers are formed. In one embodiment, the thicknesses of the first and second metal layers can individually be 100 μm or less, 50 μm or less, 25 μm or less, 10 μm or less, 5 μm or less, 3 μm or less, or 1 μm or less. In one embodiment, the thicknesses of the metal layers can be the same or different. In one embodiment, a double-sided clad can include a thin metal layer on one side and a metal foil on the other side, wherein the thin metal layer is formed using a plating process and the metal foil is subsequently laminated to the clad on a side opposite the thin metal layer. In one embodiment, a metal foil can have a thickness in a range of from 5 to 200 μm, 5 to 100 μm, 10 to 75 μm or 10 to 50 μm. In one embodiment, for a multilayer polymer film, using a thermoplastic polymer layer as an outer layer to bond to the metal layer(s) enables strong adhesion between the polymer film and metal layer(s) despite the smoothness of the interface between the layers, and without the use of additional primer or adhesive layers in between.

### Applications

In one embodiment, the clads of the present invention are useful for die pad bonding of flexible print connection boards or semiconductor devices or packaging materials for CSP (chip scale package), chip on flex (COF), COL (chip on lead), LOC (lead on chip), multi-chip module (“MCM”), ball grid array (“BGA” or micro-ball grid array), and/or tape automated bonding (“TAB”).

In another embodiment, the clads of the present invention may be used for wafer level integrated circuit packaging, where a composite is made using a polymer film according to the present invention interposed between a conductive layer (typically a metal) having a thickness of less than 100 μm, and a wafer comprising a plurality of integrated circuit dies. In one (wafer level integrated circuit packaging) embodiment, the conductive passageway is connected to the dies by a conductive passageway, such as a wire bond, a conductive metal, a solder bump or the like.

In another embodiment, the clads of the present invention are used as a material to construct a planar transformer component. These planar transformer components are commonly used in power supply devices.

In another embodiment, the clads of the present invention are used as a material to construct high density integrated circuitry (HDIC) including ultra-fine features, such as very tight pitches and very fine lines and spacings, which supports good signal integrity of high speed signal transmission at high frequency. Such circuitry is used for the construction of display module, touch sensor panel, sensors, and camera modules in mobile electronic devices.

In one embodiment, a shielding film, which provides EMI shielding for electronic devices and components, such as flexible circuit boards, antennas, and chip-on-flex, includes a clad. To provide EMI shielding, the shielding film includes a uniform metal layer, that is highly conductive, strongly adherent to the base material, and has a long-term retention of high electrical conductivity.

In yet another embodiment, the clads of the present invention may be used with thick metal foils to form resistive heaters, such as those describe is U.S. Patent Application No. 2011/0229680 A1. These heaters are typically used in automotive and aerospace applications.

In one embodiment, clads having a polymer film and first and second metal layers adhered to the polymer film, can be used as current collectors in electrochemical devices, such as lithium-ion batteries, capacitors, super capacitors, fuel cells, and redox flow batteries. Any electrochemical device where the conductivity of a current collector may be useful to complete a circuit and deliver power an external device could benefit from the use of current collectors having a polymer film and metal layers adhered to the polymer film. For example, a lithium-ion cell includes a positive electrode (cathode), a negative electrode (anode), and a separator, at least one of which, preferably all of which, are in ionically conductive contact with an electrolyte solvent.

The advantageous properties of this invention can be observed by reference to the following examples that illustrate, but do not limit, the invention. All parts and percentages are by weight unless otherwise indicated.

### EXAMPLES

### Test Methods

### Particle Size

Particle size of filler particles in the slurries was measured by laser diffraction using a particle size analyzer (Mastersizer 3000, Malvern Instruments, Inc., Westborough, MA). DMAc was used as the carrier fluid.

### Surface Resistivity

Following ASTM D257, to measure surface resistivity, a Loresta AX MCP-T370 equipped with a PSP Linear 4-point probe (Mitsubiushi Chemical Analytech Co., LTD, Kanagawa, Japan) was used to measure surface resistivity in 15 locations spread evenly across a ˜12″×12″ piece of polymer film. The 15 measurements were averaged to determine the surface resistivity of the film. Surface resistivity can be measured on either side of the polymer film containing electrically conductive fillers.

### Metal Detection

Approximately 300 mg of clad was digested in aqua regia in enclosed microwave digestion vessels at 900 W for 15 minutes. Internal temperatures of vessels reached ˜250° C. The samples were cooled to room temperature after digestion and inspected for total dissolution of solids. Samples were then placed on a hotplate to drive off the aqua regia. Once dry, each sample was reconstituted in a 2% HNO₃ v/v solution. The diluted samples were analyzed in triplicate for 105-Pd with He and H₂ collision cell gas on an inductively coupled plasma mass spectrometer (7700 ICP-MS 6, Agilent Technologies, Santa Clara, CA).

### Carbon Black Slurry

For some embodiments a carbon black slurry was prepared to provide an electrically conductive filler, consisting of 9.5 wt % carbon black powder (Conductex® 7055U, Aditya Birla Group, Marietta, GA), 17.25 wt % polyamic acid (13.06 wt % PMDA/ODA and 4.19 wt % PMDA/BPDA//ODA/PPD) and 73.25 wt % DMAc. Milling and high shear mixing were used for complete uniform particle dispersion of the slurry. The median particle size, d₅₀ (the equivalent spherical diameter based on a median volume distribution of the particles), of filler particles was less than 1 μm.

### Multilayer Polymer Film

Polyamic acid solutions for producing the core layer and outer layers were separately prepared by a chemical reaction between the appropriate molar equivalents of the monomers in dimethylacetamide (DMAc) solvent. Typically, the diamine dissolved in DMAc was stirred under nitrogen, and the dianhydride was added as a solid over a period of several minutes. Stirring was continued to obtain maximum viscosity of the polyamic acid. Carbon black slurry (at the appropriate loading to provide the desired surface resistivity) was added into the polyamic acid solutions and mixed using a high shear mixer. The viscosity was adjusted by controlling the amount of dianhydride in the polyamic acid composition.

### Examples 1 to 3

For Examples 1 to 3 (E1-E3), a two-layer polyimide film with an electrically conductive layer on one side and a dielectric insulator on the other side (DuPont™ Kapton® 200RS100, available from DuPont de Nemours, Inc., Wilmington, DE) was used as the multilayer polymer film. Both layers contained a polyimide derived from an approximately 1:1 molar ratio of dianhydride to diamine, the dianhydride being PMDA and the diamine being ODA. For these films, surface resistivity was measured on the surface with the electrically conductive layer.

### Example 4

For Example 4 (E4), the core layer polymer composition contained a polyimide derived from an approximately 1:1 molar ratio of dianhydride to diamine. The dianhydride composition contained the monomers BPDA/PMDA in a 88:12 molar ratio and the diamine composition contained the monomers PPD/ODA in a 95:5 molar ratio. The thermoplastic outer layers also contained a polyimide derived from an approximately 1:1 molar ratio of dianhydride to diamine. The dianhydride composition contained the monomers PMDA and ODPA in a 20:80 molar ratio and the diamine composition was 100 mole % RODA monomer.

Multilayer films were cast by co-extrusion. Three separate polyamic polymer streams were simultaneously extruded through a multi-cavity extrusion die onto a heated moving belt to form a co-extruded three-layer polyimide film. The flow rates of the polyamic acid solutions were adjusted to yield a three-layer film in which the core layer was approximately 38 μm thick and the thermoplastic outer layers were each approximately 6 μm thick. The film of E4 included enough carbon black slurry to provide a surface resistivity of approximately 100 Ω/sq.

The extruded multilayer film was dried at an oven temperature in the range of from about 95 to about 150° C. The self-supporting film was peeled from the belt and heated with radiant heaters in a tenter oven at a temperature of from about 110 to about 805° C. (radiant heater surface temperature) to completely dry and imidize the polymers.

E1-E4 films were metallized with copper to form a metal layer on a polymer film. Prior to metallization, film samples were cut to roughly 5 in² or 25 in² and clipped into a stainless-steel frame. All film surfaces were cleaned using a 2-step plasma treatment process. Cleaning was carried out at 300 mTorr of plasma exposure with a N₂/CF₄/O₂ mixture for 5 minutes for the first step, followed by 30 seconds of exposure to O₂ plasma for the second step. After plasma treatment, films were submerged into a 1M NaOH water solution at 45° C. for 90 seconds with gentle agitation, then rinsed with flowing tap water for 2 minutes. Finally, films were plated electrolytically in a plating cell as described below.

Electroplating was done using a DuPont MICROFILL™ EVF-II process. Copper electroplating baths were prepared by combining 200 g/L copper as copper sulfate pentahydrate, 100 g/L sulfuric acid, 50 ppm chloride ion, 1.25 ml/L of MICROFILL™ EVF-II XB, 33 ml/L of an MICROFILL™ EVF-II XL and 10 ml/L of MICROFILL™ EVF-II XC. Films were electrolytically plated in a 5.5 L or a 1.5 L plating cell with air agitation set to 2 LPM and temperature was controlled at 75° F. (24° C.) via heated water bath. Films were mounted between two 5″×7″ or 2″×6″ stainless steel frames with a 4.5″×5.5″ or a 1.5″×3.25″ window and treated as follows:
1. Films were plated at the current density shown in Table 1 for 10 minutes 24 seconds in a bright acid copper bath to a target thickness of 1 km.
2. Following electrolytic copper plating the films were rinsed with DI water for 120 seconds, removed from the frame, immersed in ANTITARNISH™ 7130 (DuPont) for 15 seconds, rinsed with DI water for 30 seconds and dried in air.

### Comparative Example 1

For Comparative Example 1 (CE1), the polymer composition contained the same polyimide as describe for E4. The film was cleaned using the 2-step plasma process described above followed by the post-plasma base rinse.

After plasma treatment, electroless plating was performed for the film of CE1, prior to electrolytic plating, by processing the film sequentially using a CIRCUPOSIT™ 6500 Electroless Copper deposition process without use of a desmear step and treated as follows:
1. The film was immersed in CIRCUPOSIT™ 6520A Pre-Dip (DuPont de Nemours, Inc., Wilmington, DE) at pH 2 at room temperature for 30 seconds with gentle agitation.
2. The film was then immersed in CIRCUPOSIT™ 6530 Catalyst (DuPont) made-up at 200 ppm Pd²⁺ ion concentration at 50° C. for 60 seconds with gentle agitation.
3. The film was then rinsed with flowing tap water for 60 seconds.
4. The film was then immersed in CIRCUPOSIT™ 6540 Reducer Solution (DuPont) at 32° C. for 60 seconds with gentle agitation.
5. The film was then rinsed with flowing tap water for 60 seconds.
6. The film was then immersed in a CIRCUPOSIT™ 6550 Electroless Copper Plating Bath (DuPont) at about 34° C. for 2.5 minutes.
7. The film was then rinsed with flowing tap water for 60 seconds.

After electroless plating, the film of CE1 was dried and stored in a desiccator before use for electroplating.

The electroless plating process forms an approximately 80-120 nm layer of copper on the polyimide film. The electroless plating process was then followed by an electrolytic plating process, which was performed by processing the film sequentially using the MICROFILL™ EVF-II process described above. Prior to placing the film into the MICROFILL™ EVF-II bath, it was pre-cleaned as follows:
1. The film was pretreated with RONACLEAN™ LP-200 cleaner (DuPont) for 120 seconds at 40° C.
2. The film was then rinsed in deionized (DI) water for 120 seconds.
3. The film was then treated in 40 g/L sulfuric acid for 30 seconds before transferring to the electrolytic plating bath.

TABLE 1

| | | | Current | Surface | | Pd |
|---|---|---|---|---|---|---|
| Ex- | Core Layer | Outer Layer | Density | Resistivity | Cover- | Content |
| ample | Polyimide | Polyimide | (ASD) | (Ω/sq) | age | (ppm) |
| E1 | PMDA/ | PMDA/ | 0.54 | 96 | full | 0.1 |
| | ODA | ODA | | | | |
| E2 | PMDA/ | PMDA/ | 1.08 | 96 | edge | 0.0 |
| | ODA | ODA | | | | |
| E3 | PMDA/ | PMDA/ | 0.27 | 96 | full | 0.0 |
| | ODA | ODA | | | | |
| E4 | PMDA/ | PMDA/ | 0.54 | 97 | full | 0.0 |
| | ODA | ODPA// | | | | |
| | | RODA | | | | |
| CE1 | PMDA/ | PMDA/ | 0.54 | 97 | full | 11.7 |
| | ODA | ODPA// | | | | |
| | | RODA | | | | |

Table 1 summarizes the film properties. The coverage of the metal layer is characterized as “full” (complete coverage of the polymer film by the metal layer), “edge” (some coverage of the polymer film from the edges of the film towards the middle, but with exposed polymer towards the center of the film) and “none” (essentially no metal covering any of the polymer film). E1-E4 demonstrate that a direct electrolytic plating process that directly electrochemically deposits a metal layer on a polymer film can be used to form a clad with excellent coverage of the metal layer on the polymer film without an initial electroless step using a seed layer. By adjusting the deposition parameters, such as the current density, full coverage can be achieved.

What is claimed is:

1. A clad comprising a polymer film and a first metal layer adhered to the polymer film, wherein:
the polymer film comprises an electrically conductive filler and has a surface resistivity of 1 Megaohm/square or less;
the first metal layer has a thickness of 100 μm or less;
the clad has less than 15 ppm of Pd; and
the metal layer is formed on the polymer film by directly electrochemically depositing the first metal layer on the polymer film.

2. The clad of claim 1, wherein the polymer film comprises a polymer comprising an imide group.

3. The clad of claim 2, wherein the polymer is selected from the group consisting of polyimides, poly(amide-imides), poly(ester-imides) and poly(amide-ester-imides).

4. The clad of claim 1, wherein the polymer film comprises a multilayer film comprising:
a first outer layer comprising a first polymer;
a second outer layer comprising a second polymer; and
a core layer comprising a third polymer, wherein the core layer is between the first and second outer layers and the electrically conductive filler is present in one or more of the layers.

5. The clad of claim 4, wherein one or more of the first, second and third polymers comprises a polymer comprising an imide group.

6. The clad of claim 4, wherein the first and second polymers are the same.

7. The clad of claim 1, wherein the electrically conductive filler is an inorganic filler, an organic filler or a mixture thereof.

8. The clad of claim 1, wherein the electrically conductive filler is carbon black.

9. The clad of claim 1, wherein the electrically conductive filler is present in the polymer film at a concentration in a range of from 5 to 65 weight percent based on the total weight of the polymer film.

10. The clad of claim 1, wherein the first metal layer has a thickness of 25 μm or less.

11. The clad of claim 1, further comprising a second metal layer adhered to the polymer film on a side opposite the first metal layer.

12. The clad of claim 11, wherein the second metal layer has a thickness of 25 μm or less.

13. An electronic device comprising the clad of claim 1.

14. An energy storage device comprising the clad of claim 1, wherein the energy storage device is selected from the group consisting of lithium-ion batteries, capacitors, super capacitors, fuel cells and redox flow batteries.

15. A shielding film for electronic circuitry comprising the clad of claim 1.

16. A resistive heater comprising the clad of claim 1.
